(19) United States
(12) Patent Application Publication
(10) Pub. No.: US 2007/0124271 A1
(43) Pub. Date: May 31, 2007

(54) Method and system for managing file aliases

(75) Inventors: Frederic Bauchot, Saint-Jeannet (FR); Jean-Luc Collet, La Gaude (FR); Gerard Marmigere, Drap (FR)

Correspondence Address: PASTEL LAW FIRM, 8 PERRY LANE, ITHACA, NY, 14850, US

(73) Assignee: International Business Machines Corporation, Armonk, NY (US)

(21) Appl. No.: 11/543,664

(22) Filed: Oct. 5, 2006

(30) Foreign Application Priority Data
Nov. 25, 2005 (EP) EP05300964

(51) Int. Cl. G06F 17/30

(52) U.S. Cl. 707/1

(57) ABSTRACT

A method, system, or computer program manages file names as multi-field character strings by defining each file name in a list of file names as a multi-field character string, displaying the list of file names, receiving a command selecting a field within the displayed list of file names, and sorting the file names according to the selected field in the current displayed list.

### CROSS-REFERENCE TO RELATED APPLICATIONS

This application claims priority from EPO Application Serial No. EP05300964 filed on Nov. 25, 2005 and entitled METHOD AND SYSTEM FOR MANAGING

### FIELD OF THE INVENTION

This invention relates generally to the field of data processing, and more particularly to a method, system and computer program for managing file aliases.

### BACKGROUND OF THE INVENTION

Ever since the availability of the Windows 98 operating system, computer users have enjoyed getting rid of the constraining file name format “NNNNNNNN.TT” which only allowed the use of up to 8 characters for a file name and up to 3 characters for a file type. The new limits, 256 characters, are most of the time not reached, simply because nobody wants to enter so many characters for a file. This means that end users can now assign easy-to-understand names to files, and can define some kind of specific naming conventions to precisely and easily identify the information that a file contains. Furthermore if a file refers to a something referenced by an identifier within a given structure (like for instance a data base), then this identifier will naturally appear in the name of the file, to ease the retrieving and matching of information between the file system and the said structure. In the cases where multiple identifiers point to the same object, then these identifiers are relevant candidates to appear as part of a file name. This means that file names shaped as a multi-field character string such as “identifier1 identifier2 description” are today quite common on file systems.

These considerations can be illustrated by a real example. Let “File Name Alias FB V1.doc” be the name of a document describing an invention. Implicitly this name follows a format like “X*X YY VZ.doc” where X*X is a descriptive text, YY are the initials of the last file editor, and Z is a number specifying the file version.

An identifier (a “disclosure number”) is assigned to an invention, of the form “FR8 2005 nnnn.” This identifier will be used afterwards to reference this invention. At that time, it may become convenient to rename this file (or a new version of this file) as follows: “FR8 2005 0041 File Name Alias FB V3.doc” (assuming that the “disclosure number” is “FR8 2005 0041” and that it is the third version of the file). Later on, if a decision is taken to file a patent application, then a new identifier will be assigned, known as “docket number”, with the format “FR9 2005 mmmm”. This “docket number” will be used afterwards to reference the application. It may become convenient at that time to rename this file (or a new version of this file) as follows: “FR9 2005 0037 FR8 2005 0041 File Name Alias FB V4.doc” (assuming that the “docket number” is “FR9 2005 0037” and that this will be the fourth version of the file). At this stage, the file name is structured as a multi-field character string : “disclosure docket description author version. ”

With file names according to a multi-field character string format like “identifier1 identifier2 description”, the conventional tools available on top of the operating systems are very convenient to provide sorting facilities, as long as the sorting operation is performed on the leftmost field of the name, that is the “identifier1” field. But if a user needs to re-order multiple files according to the “identifier2” field, then the conventional tools will not help. As the user does nor want to drop the “identifer1” field, then sorting operations cannot be performed on other fields of the file name.

With the example previously introduced, let us assume that an inventor wants to retrieve from his/her hard disk the plurality of files created when working on a former patent. Let us assume that the inventor has forgotten the “disclosure number” and the “docket number”, but can remember quite well the “patent name”. For this particular search, the user needs to sort all the files present within his/her “patent” directory. This operation requires a sorting on the “description” field. As the “description” field is not the left most field of the file name, the conventional tools available in current operating system cannot provide any solution to this problem.

In short, the problem to solve consists of enabling a user to define easily file names comprising multi-field character strings, and to perform conventional file name operations, such as file sorting, as if each individual field present in the file name would appear as the left most field.

### SUMMARY AND OBJECTS OF THE INVENTION

Briefly stated, a method, system, and computer program manages file names as multi-field character strings by defining each file name in a list of file names as a multi-field character string, displaying the list of file names, receiving a command selecting a field within the displayed list of file names, and sorting the file names according to the selected field in the current displayed list.

According to an embodiment of the invention, a computer implemented method for managing file names as multi-field character strings includes the steps of (a) defining, in a list of file names, each file name as a multi-field character string; (b) displaying the list of file names; (c) receiving a command selecting a field in the displayed list of file names; and (d) sorting, in the current displayed list, the file names according to the selected field.

According to an embodiment of the invention, a system for managing file names as multi-field character strings includes means for defining, in a list of file names, each file name as a multi-field character string; means for displaying the list of file names; means for receiving a command selecting a field in the displayed list of file names; and means for sorting, in the current displayed list, the file names according to the selected field.

According to an embodiment of the invention, a computer program product comprising a computer usable medium including computer usable program code for managing file names as multi-field character strings includes (a) computer usable program code for defining, in a list of file names, each file name as a multi-field character string; (b) computer usable program code for displaying the list of file names; (c) computer usable program code for receiving a command selecting a field in the displayed list of file names; and (d) computer usable program code for sorting, in the current displayed list, the file names according to the selected field.

It is an object of the present invention to build and manage file names or directory names as a multi-field character strings.

It is a further object of the present invention to define one or a plurality of special characters aimed to delimit the fields present in a file or directory name consisting of a multi-field character string.

It is a further object of the present invention to change the order of fields when displaying the fields contained in a multi-field character string file name.

It is a further object of the present invention to change the name of a file or directory by a sequence of ordered fields.

### BRIEF DESCRIPTION OF THE DRAWINGS

FIG. 1 shows the Windows Explorer initial display when first opened.

FIG. 2 shows the Windows Explorer display after a first shift left.

FIG. 3 shows the Windows Explorer display after a second shift left.

FIG. 4 shows the Windows Explorer PopUp menu with the function according to the present invention.

FIG. 5 shows New Shift buttons associated with the name column of Windows Explorer according to the present invention.

FIG. 6 shows the customization of the default file name Column.

FIG. 7A is a flow chart showing the Dynamic Link Library (DLL) installation according to the present invention.

FIG. 7B is a flow chart showing the Dynamic Link Library (DLL) desinstallation according to the present invention.

FIG. 7C is a flow chart showing the Dynamic Link Library (DLL) initialization according to the present invention.

FIG. 7D is a flow chart of the Dynamic Link Library (DLL) process according to the present invention.

FIG. 8 shows the real file name compared with the displayed file name.

### DETAILED DESCRIPTION OF THE PREFERRED EMBODIMENT

The following description is presented to enable one or ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein. Moreover, any skilled person in the art would easily adapt this invention in other type of applications using object, file, or directory names in such mail clients as IBM Lotus Notes, Microsoft Outlook Express, etc.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is based on the following three principles.

(1) The name Fn of a file is structured according to the following format:
Fn=field_{—}1 & field_{—}2 & . . . & field_{—}n

where a specific delimiter character (“&” in the case above) is reserved to delimiter fields, and “field_i” is a character string where the delimiter character does not appear. In this way, the file name Fn fully complies with the file naming constraints defined by the conventional operating systems like the Windows environment of Microsoft Corporation.

(2) The file management application running in a conventional operating system, such as Windows Explorer, is enhanced with a new function to perform a circular permutation of the fields present in the multi-field character string file name, so that each individual field “field_i” can appear as the leftmost field of the file name. In the rest of this document, this operation will be referred to as a “shift” 510 (FIG. 5).

It must be noted here that this kind of permutation does not mean that the file name, as it appears in the internal tables of the operating system, such as the File Allocation Table (FAT), is changed, but rather that the way to display the file name on the file management application window is changed. The advantage is to limit the impact of the present invention to the file management application because there is no impact on the internals of the operating system.

It must be also noted that onceone or a plurality of shift operations have been executed, all the conventional functions available within the file management application remain available. All these conventional functions operate as if the current file name corresponds to the output of the last shift operation.

It must be finally noted that the circular permutation has been chosen in the preferred embodiment to simplify the user interface depicted in FIG. 5, but any other reordering of the fields present in the multi-field character string file name may be implemented with an associated more complex user interface.

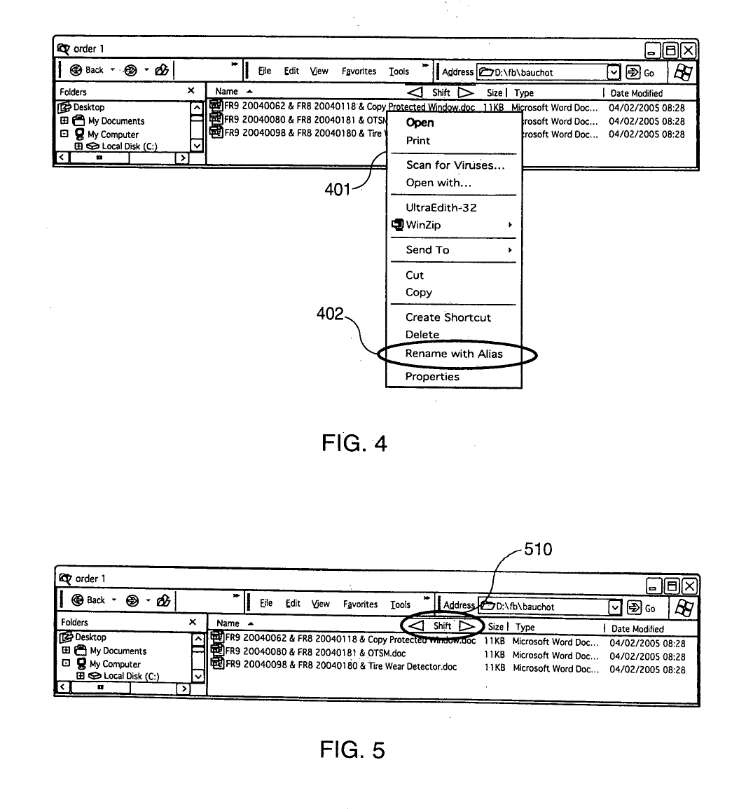

(3) The file management applications running in conventional operating systems, such as Windows Explorer, are also enhanced with another new command. The purpose of this new command is to update the name of currently selected files with a currently displayed name. This feature, which updates the internal tables of the operating system, such as the File Allocation Table (FAT), records, as an updated file name, the output of a shift operation as described in the previous step. In the rest of this document, this operation will be referred to as “Rename with Alias” 402 (FIG. 4).

The operation “Rename with Alias” can be illustrated by means of the following example, based on the previous case dealing with files associated with inventions. Let us assume that a directory named “PATENT” is made up of the three following files, with the file names being structured according to the format “docket disclosure description.”

FR9 2004 0062 & FR8 2004 0118 & Copy Protected Window.doc

FR9 2004 0080 & FR8 2004 0181 & OTSM.doc

FR9 2004 0098 & FR8 2004 0180 & Tire Wear Detector.doc

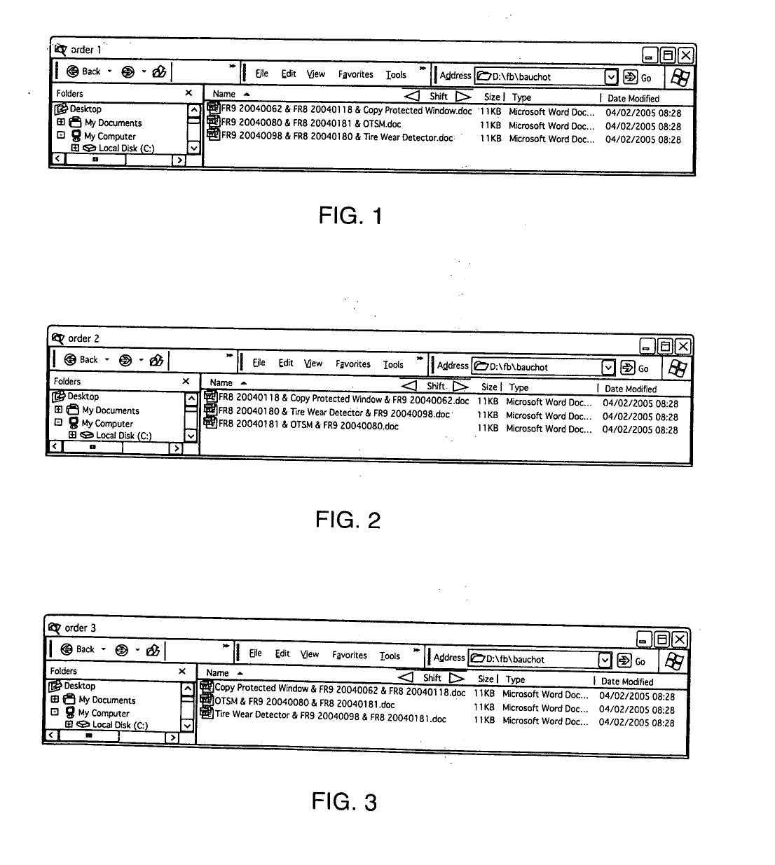

As shown in FIG. 1, when the Windows Explorer window is first opened, the names of the three files appear in the “PATENT” directory with the format “docket disclosure description.”

As shown in FIG. 2, the result of a first shift left operation puts the “disclosure” field as the left most displayed field, so that the format is displayed as follows: “disclosure description docket”. The new list appears as follows:

FR8 2004 0118 & Copy Protected Window & FR9 2004 0062.doc

FR8 2004 0181 & OTSM & FR9 2004 0080.doc

FR8 2004 0180 & Tire Wear Detector & FR9 2004 0098.doc

As shown in FIG. 3, the result of a second shift left operation puts the “description” field as the leftmost displayed field, so that the format is displayed as the following: “description docket disclosure.” The new list appears as follows:

Copy Protected Window & FR9 2004 0062 & FR8 2004 0118.doc

OTSM & FR9 2004 0080 & FR8 2004 0181.doc

Tire Wear Detector & FR9 2004 0098 & FR8 2004 0180.doc

Should a third shift left operation be performed, this would bring us back to the original format shown in FIG. 1 since the multi-field file name structure contains three fields in the present example. At this stage, the file name of the three files present in the “PATENT” directory has not been changed because the shift operation only impacts the way the fields present in the file name are displayed. If the user at this step, wants to update the file name by keeping the “description” field as the left most field, then he will have only to perform a “rename” operation. The displayed names become the file names, as recorded in the operating system internal tables such as the FAT.

Referring to FIGS. 1-4, the steps of the method of the invention are described. First, as shown in FIG. 1, the files are displayed according to the format “docket disclosure description” and are sorted. In the present step, the sorting operation is performed according to the “docket number.”

Second, a first “shift” operation is performed, so that the format becomes “disclosure description docket”, after which a conventional sort operation is performed. As shown in FIG. 2, the file order is changed because the sequence of disclosure numbers does not follow the sequence of docket numbers any more.

Third, a second “shift” operation is performed, so that the format becomes “description docket disclosure”, after which a conventional sort operation is performed (see FIG. 3).

Fourth, the user finally can replace the file name by the currently shifted file name displayed on the screen. This operation can be done as follows. The user clicks with the pointing device on the selected file and a popup menu appears as shown in FIG. 4. The displayed menu includes an option list 401. Within this list 401, the user selects the new entry “Rename with Alias” 402. The resulting effect is that the selected file is renamed with the current displayed shifted file name.

The Microsoft Windows® Shell API (Application Programming Interface) is now described. In the preferred embodiment, the invention described hereafter relies on the Microsoft Windows® operating system family. The present invention is based on the concept of building and managing a file name as a multi-field character string.

The Microsoft Windows® User Interface (UI) gives users access to a wide variety of objects necessary for running applications and managing the operating system. The most numerous and familiar of these objects are the folders and files that reside on computer disk drives. There are also a number of virtual objects to do tasks, such as sending files to remote printers or accessing the Recycle Bin. The Shell organizes these objects into a hierarchical structure called “namespace”. The “namespace” provides users and applications with a consistent and efficient way to access and manage objects. Users interact with the “namespace” through the Shell's graphical user interface (GUI) or through an application. Applications interact with the “namespace” through the Shell's API.

The Shell API includes a collection of functions, Component Object Model (COM) interfaces, and COM objects providing applications with a rich set of tools to access and manage the “namespace”. The Shell API allows applications to perform a variety of tasks. Some of the more common tasks are:

Getting a Folder's ID,

Getting Information About the Contents of a Folder,

Navigating the Namespace,

Launching Applications,

Managing the File System,

Managing Printers,

Transferring Shell Objects with Drag-and-Drop and the Clipboard,

Debugging with the Shell,

Scriptable Shell Objects, and

Extending the Shell.

A person of ordinary skill in the art can extend the Shell's functionality and customize certain aspects of its behavior.

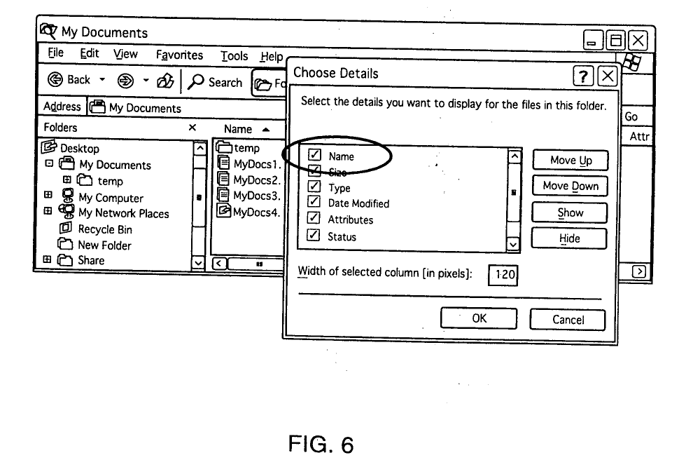

The present invention also permits customizing the Shell with the management of files aliases. As shown in FIG. 5, on the Name toolbar header, at 510, the user can shift the name of the current folder files left or right. The Microsoft Windows® Explorer normally displays several standard columns. Each column lists information for each file in the current folder, such as the file size or type. Each column is associated with a Column Handler Dynamic Link Library (DLL) in charge of managing this information (file size, file name, etc.). The person of ordinary skill in the art can customize the behavior of such Column Handlers by adding new features such as the management of file aliases. The Microsoft Windows® Shell extension API used in the present invention focuses on the implementation of a new Column Handler Library to allow the management of aliases. With Microsoft Windows® 2000 for example, a folder can support a number of columns that are not displayed by default. The user can display additional columns by right-clicking one of the column headers and by selecting the “More” command from the menu. A dialog box then appears that lists the available columns for the folder and gives the user the possibility to select which columns to display. FIG. 6 shows the dialog box described in this example.

In the present invention, the Microsoft Windows® Column Handler interface is used to overwrite the Default Column Handler behavior for the file names to display and manage file aliases. A Column Handler is a global object that is called every time Microsoft Windows® Explorer displays the Details view of a selected folder files list. Before it displays the Details view, Windows® Explorer queries all registered Column Handlers for their column characteristics. If the user has selected one column, Windows® Explorer queries the Column Handler for the associated data. When a Column Handler receives a request for data, it provides it.

A more detailed sample of a Column Handler implementation can be found at the following URL :http://www.codeproject.com/shell/DirectorySize.asp. The Microsoft Windows® shell extension API is maintained and published by Microsoft and can be found on their web site. Extending shortcut menus within the Shell Explorer is also part of the customizable elements of the Shell API as shown in FIG. 4. More technical details can be found at the Microsoft web site.

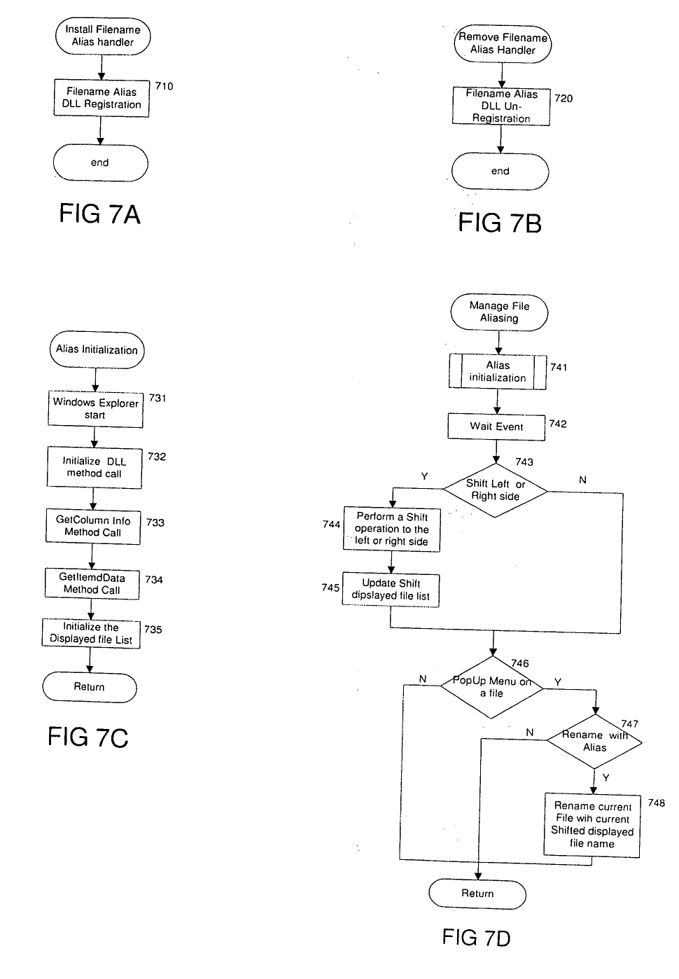

The embodiment described hereafter is based on the Microsoft Windows® operating system family API. The implementation of this invention consist in developing a new Column Handler Dynamic Link Library (DLL) managing for all the file types, the name alias data & behavior. This library is first installed on the system either by an installation program or manually by the administrator of the system. As shown in FIGS. 7A-7B, the installation and deinstallation process consists of registering the Column Handler Dynamic Link Library (DLL) at step 710 into the Microsoft Windows® operating system so that it can be recognized as a shell extension for file alias management. Step 720 in shows the deinstallation.

FIG. 7C shows a flow chart showing the Dynamic Link Library (DLL) initialization according to the present invention. At step 731, once registered and initialized, the Dynamic Link Library (DLL) is activated when the Microsoft Windows® File Explorer is launched. At step 732, the Microsoft Windows® operating system calls the “Initialize” task to initialize the Column Handler Dynamic Link Library (DLL). At step 733, the Microsoft Windows® Explorer calls a “GetColumnInfo” task to request the identifier and characteristics of the column. At step 734, the Microsoft Windows® Explorer calls a “GetItemData” primitive for each file in the folder that must be displayed as shown in FIG. 5. This task is performed by the column handler library as described above. This task allows the File Explorer to retrieve the information associated with each files of a given folder. The “GetItemData” primitive returns the filename aliases associated with each file. At step 735, the Microsoft Windows® Explorer renders the filename aliases, using the information returned by the “GetItemData” task, in the file name column as shown in FIG. 5.

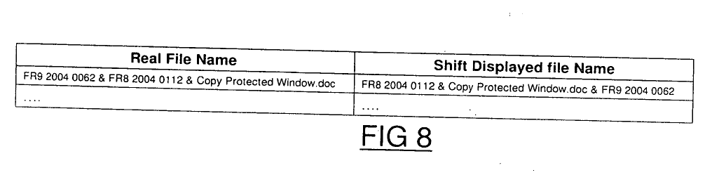

The Shift displayed list of files belonging to the current folder is initialized. This list is maintained by the Column Handler Dynamic Link Library (DLL) and corresponds to the displayed list of file names shown in FIG. 8.

Each time a shift operation is requested by the user (by clicking the shift button 510 in FIG. 5), the Column Handler DLL performs a left or a right shift operation. This operation consists of performing a left or right circular permutation of the fields present in the multi-field character string file name, so that each individual field “field_i” can appear as the leftmost field of the file name. Each field is identified by a delimiter character (shown as “&” in this embodiment of the present invention). This process is described in the flow chart shown in FIG. 7D. At step 741, the Column Handler is initialized. At step 742, the Column Handler is in an idle state waiting for user inputs. At step 743, the user clicks with the pointing device on the Shift left or Shift right button 510 to modify the current display order within the multi-string file name.

At step 744, the DLL performs a left or right shift operation on the current displayed file name list. This operation consists of performing a left or right circular permutation of the various fields of the displayed file name aliases (as shown in FIG. 8). For instance, a left shift operation on the file name alias “FR9 2004 0062 & FR8 2004 0118 & Copy Protected Window.doc” will change the current displayed file name alias to “FR8 2004 0118 & Copy Protected Window & FR9 2004 0062.doc”.

At step 745, the Column Handler DLL refreshes the current list of filename aliases according to the previous operation (left or right shift operation). At step 746, the user right clicks on a current displayed file name in the name column. The file context popup menu is displayed to the end-user. At step 747, the user selects within this popup menu a new feature called “Rename with Alias” to rename the current file with the current displayed file name. At step 748, the current displayed file name is used to rename the file on the file system. The selected file is renamed with the current displayed shifted file name.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. A computer implemented method for managing file names as multi-field character strings, comprising the steps of:
defining, in a list of file names, each file name as a multi-field character string;
displaying said list of file names;
receiving a command selecting a field in said displayed list of file names; and
sorting, in the current displayed list, the file names according to said selected field.

2. The method according to claim 1, wherein the step of defining further comprises the step of defining at least one specific character to delimit each field.

3. The method according to claim 1, wherein the step of defining further comprises the step of defining each file name as a sequence of ordered fields.

4. The method according to claim 1, wherein the step of sorting further comprises sorting the file names in said displayed list as if the selected field was the leftmost field in said file names.

5. The method according to claim 4, wherein the step of sorting further comprises the step of performing a left or right circular permutation of the fields when displaying the file names such that the selected field appears as the left most field in said file names.

6. The method according to claim 1, further comprising the step of updating the name of each file with the currently displayed file name.

7. The method according to claim 6 wherein said method is carried out by a computer system comprising an operating system with internal tables where file names are listed, and wherein the step of updating further comprises the step of updating the name of each file in the internal tables of the operating system with the currently displayed file names.

8. The method according to claim 1, wherein files are accessed by users using an operating system user interface and wherein said operating system is based on the Windows operating system family.

9. The method according to claim 1, wherein said file names are directory names.

10. A system for managing file names as multi-field character strings, comprising:
means for defining, in a list of file names, each file name as a multi-field character string;
means for displaying said list of file names;
means for receiving a command selecting a field in said displayed list of file names; and
means for sorting, in the current displayed list, the file names according to said selected field.

11. The system according to claim 10, wherein the means for defining further comprises means for defining each file name as a sequence of ordered fields.

12. The system according to claim 10, wherein the means for sorting further comprises means for sorting the file names in said displayed list as if the selected field was the leftmost field in said file names.

13. The system according to claim 12, wherein the means for sorting further comprises means for performing a left or right circular permutation of the fields when displaying the file names such that the selected field appears as the left most field in said file names.

14. The system according to claim 10, further comprising means for updating the name of each file with the currently displayed file name.

15. A computer program product comprising a computer usable medium including computer usable program code for managing file names as multi-field character strings, said computer program product including:
(a) computer usable program code for defining, in a list of file names, each file name as a multi-field character string;
(b) computer usable program code for displaying said list of file names;
(c) computer usable program code for receiving a command selecting a field in said displayed list of file names; and
(d) computer usable program code for sorting, in the current displayed list, the file names according to said selected field.

16. The computer program product according to claim 15, further comprising computer usable program code for defining each file name as a sequence of ordered fields.

17. The computer program product according to claim 15, further comprising computer usable program code for sorting the file names in said displayed list as if the selected field was the leftmost field in said file names.

18. The computer program product according to claim 17, further comprising computer usable program code for performing a left or right circular permutation of the fields when displaying the file names such that the selected field appears as the left most field in said file names.

19. The computer program product according to claim 15, further comprising computer usable program code for updating the name of each file with the currently displayed file name.

20. The computer program product according to claim 15, further comprising computer usable program code for updating the name of each file in internal tables of an operating system with the currently displayed file names.
